(19) United States
(12) Patent Application Publication
(10) Pub. No.: US 2017/0039072 A1
(43) Pub. Date: Feb. 9, 2017

(54) METHOD FOR BRANCH PREDICTION

(71) Applicant: International Business Machines Corporation, Armonk, NY (US)

(72) Inventors: Wolfgang Gellerich, Boeblingen (DE); Bernhard Kick, Waldenbuch (DE); Gerrit Koch, AMMERBUCH (DE); Chung-Lung K. Shum, Wappingers Falls, NY (US)

(21) Appl. No.: 14/929,452

(22) Filed: Nov. 2, 2015

Related U.S. Application Data
(63) Continuation of application No. 14/818,347, filed on Aug. 5, 2015.

(51) Int. Cl. G06F 9/38; G06F 9/30

(52) U.S. Cl. CPC G06F 9/3806; G06F 9/30058; G06F 9/30065

(57) ABSTRACT

The invention relates to a method for predicting branch instructions in a processor and a processor configured for this method. The processor includes an execution unit, an instruction fetch unit and a branch prediction unit. The execution unit is configured for executing machine instructions of a binary computer program. The branch prediction unit is configured for predicting the behavior of branch instructions executed by the execution unit. The instruction fetch unit is configured for fetching and pipelining instructions to be executed by the execution unit.

### BACKGROUND

The present invention relates to a method for branch predictions. Furthermore, the invention relates to a processor core configured for executing a method for branch prediction.

Customers expect performance improvements for every new computer model. In the past, advances in solid state physics allowed increasing clock frequency from about 1 MHz around 1980 to several GHz today. However, currently, solid state physics cannot deliver further improvements. Increased speed of program execution must come from improved CPU structure.

Normally, the machine instructions of a binary computer program are executed one after each other. The instructions are fetched and pipelined by an instruction fetch unit and executed by an execution unit. Branch instructions may interrupt the sequential execution and redirect program execution to somewhere else. Branch instructions are used to implement high-level program constructs as well as for all kinds of loops. On some CPUs branch instructions are also used to implement subprogram calls.

Several systems provide instructions tailored towards the implementation of counting loops. These branch instructions form a loop and consider a given counter as loop counter, increment or decrement this counter, and branch depending on whether the new counter value reached a reference value.

The overlapping, pipelined execution of instruction as used by many processors complicates the execution of branch statements. The address of the next instruction to execute is only known after the branch instruction has completed. However, at the point where the execution of a branch instruction is complete, the instruction fetch unit has already begun to fetch and pipeline instructions following the branch instruction. Depending if the branch is taken or not, the pipeline needs to execute different instructions, starting at the target address of the branch. This, however, requires a new pipeline start at the target address, thus delaying program execution.

Branch prediction with a very high hit rate is essential to achieve good program execution speed on today's pipelined processors. For “on count”-type branch instructions which also manage a register keeping a loop counter, knowing the counter value and the loop boundary can be exploited to precisely predict the branch instruction's future behavior without relying on heuristic algorithms.

### SUMMARY

According to an embodiment of the invention, a method for predicting branch instructions in a processor is provided.

According to one embodiment of the present invention, a computer-implemented method for predicting branch instructions in a processor is provided. The computer-implemented method may include: processing a branch instruction of a binary computer program controlling a loop by an execution unit, the branch instruction being fetched by an instruction fetch unit and comprising a counter which is decremented or incremented when the branch instruction is completed and a reference value for the total number of iterations of the loop to be executed by the execution unit; determining the number of remaining iterations for the loop by the execution unit from the counter and the reference value, for the processed branch instruction; sending the number of remaining iterations of the loop from the execution unit to a branch prediction unit when the branch instruction is completely executed; predicting, by the branch prediction unit, the future behavior of the processed branch instruction on the basis of the number of remaining iterations of the loop; and fetching and pipelining future instructions of the binary computer program by the instruction fetch unit depending on the prediction of the future behavior of the branch instruction.

According to yet another embodiment of the present invention, a computer program product for predicting branch instructions in a processor is provided. The computer program may include one or more computer-readable storage media and program instructions stored on the one or more computer-readable storage media, the program instructions comprising: program instructions to process a branch instruction of a binary computer program controlling a loop by an execution unit, the branch instruction being fetched by an instruction fetch unit and comprising a counter which is decremented or incremented when the branch instruction is completed and a reference value for the total number of iterations of the loop to be executed by the execution unit; program instructions to determine the number of remaining iterations for the loop by the execution unit from the counter and the reference value, for the processed branch instruction; program instructions to send the number of remaining iterations of the loop from the execution unit to a branch prediction unit when the branch instruction is completely executed; program instructions to predict, by the branch prediction unit, the future behavior of the processed branch instruction on the basis of the number of remaining iterations of the loop; and program instructions to fetch and pipeline future instructions of the binary computer program by the instruction fetch unit depending on the prediction of the future behavior of the branch instruction.

According to another embodiment of the present invention, a computer system for predicting branch instructions in a processor is provided. The computer system may include one or more computer processors; one or more computer-readable storage media; program instructions stored on the computer-readable storage media for execution by at least one of the one or more processors, the program instructions comprising: program instructions to process a branch instruction of a binary computer program controlling a loop by an execution unit, the branch instruction being fetched by an instruction fetch unit and comprising a counter which is decremented or incremented when the branch instruction is completed and a reference value for the total number of iterations of the loop to be executed by the execution unit; program instructions to determine the number of remaining iterations for the loop by the execution unit from the counter and the reference value, for the processed branch instruction; program instructions to send the number of remaining iterations of the loop from the execution unit to a branch prediction unit when the branch instruction is completely executed; program instructions to predict, by the branch prediction unit, the future behavior of the processed branch instruction on the basis of the number of remaining iterations of the loop; and program instructions to fetch and pipeline future instructions of the binary computer program by the instruction fetch unit depending on the prediction of the future behavior of the branch instruction.

### BRIEF DESCRIPTION OF THE DRAWINGS

In the following embodiments of the invention are explained in greater detail, by way of example only, making reference to the drawings in which;

FIG. 1 shows a schematic view of the processor core and the flow of information between the components of the processor, according to an exemplary embodiment;

FIG. 2 shows a general structure of a first branch instruction controlling a loop and comprising a counter, according to an exemplary embodiment;

FIG. 3 shows a general structure of a second branch instruction controlling a loop and comprising a counter, according to an exemplary embodiment;

FIG. 4 shows a process diagram of the execution unit of the processor core according to FIG. 1 when executing a method for branch prediction, according to an exemplary embodiment;

FIG. 5 shows a process diagram of the branch prediction unit of the processor when executing a first embodiment of a method for branch prediction, according to an exemplary embodiment;

FIG. 6 shows a process diagram of the branch prediction unit of the processor core according to claim 1 when executing a first embodiment of a method for branch prediction, according to an exemplary embodiment.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Embodiments of the invention may have the advantage that the behavior of the currently processed branch instruction can be predicted with a very high accuracy even if the number of iterations of the loop differs every time the loop is started again.

An observation for counting loops is that the number of iterations is known upon entering the loop at runtime. Accordingly, it is known in advance how many times the branch instruction implementing the loop will be taken before control flow finally leaves the loop. This information is available in the execution unit and is communicated to the branch prediction unit before the loop is finished in order to use this information to predict the behavior of the currently processed branch instruction.

This may have the advantage that the method is applicable to loops with arbitrarily high iteration count and does not require recording a branch history which is always limited in space. Also, this method does not require any learning but will predict the end of the loop at the first occurrence of the loop correctly. History-based prediction often fails to predict the first loop exit correctly.

In embodiments of the invention, the number of remaining iterations of the loop may be compared with a threshold value by the execution unit and the number of remaining loop iterations may be sent from the execution unit to the branch prediction unit only when the number of remaining iterations of the loop is less than or equal to the threshold value.

This may have the advantage that the communication within the processor is lowered and the energy consumption is reduced. The number of remaining loop iterations is not sent every time the number is updated but only when the exit of the loop is nearby and thus future instructions of the binary computer program can be fetched and pipelined reliably.

For example, the threshold value is less than 8 or less than 4. This may have the advantage that only 2 or 3 bits may be required for each counter and the memory space for the counter is reduced.

In further embodiments, a branch prediction table entry may be generated in a branch prediction table in the branch prediction unit for each currently processed branch instruction. A first and a second counter may be provided in each branch prediction table entry. The first counter stores the number of remaining iterations of the loop received from the execution unit. The second counter counts the number of branch instructions fetched and pipelined by the instruction fetch unit and sent to the execution unit and not completely executed by the execution unit. The number of the remaining branch instructions to be fetched and pipelined by the instruction fetch unit is determined depending on the values of the first and the second counter.

The branch prediction table may have the advantage that the branch prediction unit is configured for predicting the behavior of several branch instructions. For example, the branch instruction may have an outer loop and an inner loop to be executed within the outer loop. For every loop, a branch prediction table entry would be generated so that the numbers of remaining loop iterations of the outer loop and the inner loop can be predicted independently from each other.

The value of the second counter may be decremented when information of a currently completed branch instruction is received from the execution unit and may be incremented when the branch instruction is fetched and pipelined by the instruction fetch unit.

This may have the advantage that the second counter shows at all times the actual number of branch instructions fetched and pipelined by the instruction fetch unit and sent to the execution unit and not completely executed by the execution unit and thus the number of branch instructions to be fetched and pipelined can be determined immediately when the number of remaining iterations of the loop is received from the execution unit.

The number of branch instructions to be sent to the execution unit and not completely executed by the execution unit the number may be less than or equal to the threshold value.

If the number of branch instructions to be sent to the execution unit and not completely executed by the execution unit would be higher than the number of remaining loop iterations determined by the execution unit and sent to the branch prediction unit, the finish of the branch instruction may be incorrectly predicted. Therefore, it is advantageous that the number of branch instructions sent to the execution unit and not completely executed by the execution unit is lower than the number of remaining loop iterations sent to the branch prediction unit. Especially when the number of remaining iterations of the loop is only sent when the number is less than or equal to the threshold value, the number of branch instructions to be sent to the execution unit and not completely executed must be kept below the number of remaining iterations.

The execution unit may compare the value of the counter with the reference value and perform the jump if the number of remaining loop iterations is equal to the reference value.

Hereinafter, a processor 10 and a method for branch prediction with a processor 10 are described.

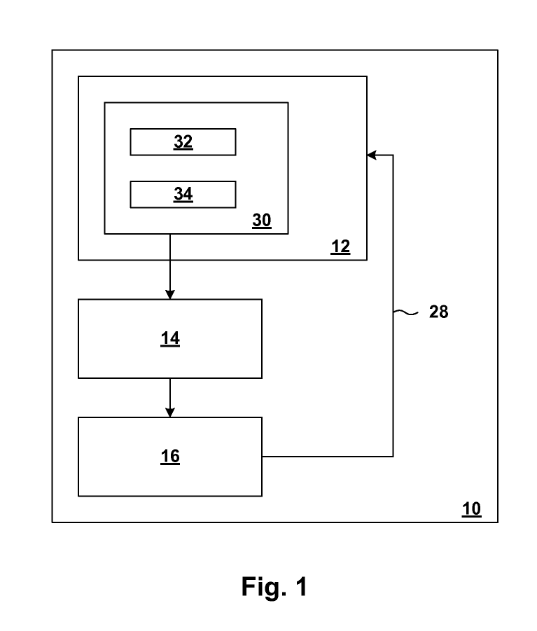

Referring to FIG. 1, the processor 10 comprises a branch prediction unit 12, an instruction fetch unit 14 and an execution unit 16. The execution unit 16 is configured to execute instruction of a binary computer program.

The instructions are fetched and pipelined by the instruction fetch unit 14. The instructions are stored in a memory of the processor 10, which is not shown in details. After fetching and pipelining the instruction, the instructions may be decoded, edited or prepared for the execution unit 16 by several other components, which are not shown in details.

Normally, the fetched and pipelined instructions are executed one after each other. Branch instructions may interrupt these sequential executions and redirect program execution to somewhere else. The overlapping, pipelined execution of instruction as used by many processors complicates the execution of branch statements. The address of the next instruction to execute is only known after the branch instruction has completed.

However, at the point where the execution of a branch instruction is complete, the instruction fetch unit has already begun fetching and pipelining instructions following the branch instruction.

Therefore, the branch prediction unit 12 is provided for predicting the target address of the branch instruction. Depending on the result of the prediction, the instruction fetch unit fetches and pipelines the next instruction to be executed by the execution unit.

The branch prediction unit 12 works asynchronously to normal program execution of the instruction fetch unit 14 and the execution unit 16. It identifies and predicts future branches independently. Therefore, fetching and pipelining the next instruction has started before the execution information of the previous instruction is received by the branch prediction unit in order to avoid delaying or idling and to improve the performance of the processor.

The processor 10 is configured for executing branch instructions of the binary computer program, which control a loop. The branch instruction is directed to a previous address so that the instructions between the previous address and the branch instruction are executed repeatedly.

The branch instruction comprises a counter and a reference value in order to determine the end of the loop. The counter is decremented or incremented each time the branch instruction is executed by the execution unit 16. The difference between the reference value and the initial value of the counter designates the total number of iterations of the loop to be executed by the execution unit. Each time the branch instruction is executed, the incremented or decremented counter is compared with the reference value in order to determine if the branch instruction has to be executed.

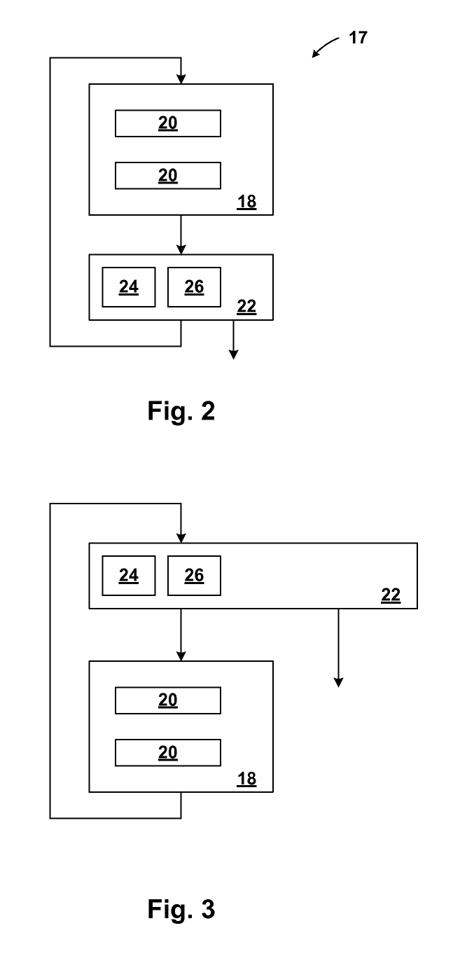

FIGS. 2 and 3 show embodiments of a general structure of a loop of a binary computer program.

The loops 17 comprise a loop body 18 and a branch instruction 22. The loop body may comprise several instructions 20, which are fetched and pipelined by the instruction fetch unit. The branch instruction comprises a counter 24 and a reference value 26.

In FIG. 2, the instructions 20 are executed before executing the branch instruction 22. When the branch instruction 22 is executed, the counter 24 of the branch instruction 22 is compared to the reference value 26. If the counter 24 is below the reference value 26, the branch instruction 22 is executed and the instructions 20 of the loop body 18 are executed again.

If the counter 24 is equal to the reference value 26, the branch instruction 22 is not executed. The loop 17 is exited and the next instruction following the branch instruction 22 respectively the loop 18 can be executed.

In FIG. 3, the branch instruction 22 is disposed before the instructions 20 of the loop body 18. The comparison of the counter 24 and the reference value 26 is performed before the instructions 20 of the loop body 18 are executed. If the counter 24 is equal to the reference value 26, the loop body 18 will be leaped and the next instruction after the loop body 18 can be executed.

An instruction 20 of the loop body itself can be a branch instruction. This instruction constitutes an inner loop and the branch instruction 22 with the loop body constitutes an outer loop.

The counter 24 can be incremented each time the branch instruction 22 is executed and the reference value 26 is the total number of iterations of the loop 17 to be executed by the execution unit 16. Alternatively, the counter 24 starts with the total number of iterations of the loop 17 to be executed the execution unit 16 and decrements each time the branch instruction 22 is executed. In this embodiment, the reference value 26 is zero. The reference value and the initial value of the counter can be selected arbitrarily if the difference of the reference value and the initial value designates the total number of iterations of the loop.

Independently from the kind of loop, when having executed the branch instruction 22 for the first time it is known how many times it will be executed and after how many iteration of the loop 17 the branch instruction 22 will be finished. By the value of the counter 24 and the reference value 26, the number of remaining iterations of the loop to be executed by the execution unit can be determined.

After finishing the branch instruction for an iteration, the execution unit sends the number of remaining loop iterations to the branch prediction unit (see FIG. 1, reference numeral 28).

A branch prediction table entry is generated in a branch prediction table 30 in the branch prediction unit 12 for each currently processed branch instruction 22, which comprises a counter 24. If an inner loop and an outer loop are present, a branch prediction table entry for each loop is provided.

Each branch prediction table entry comprises a first counter 32 in which the number of the remaining loop iterations is stored, which is sent from the execution unit 16 to the branch prediction unit 12. Furthermore, each branch prediction table entry comprises a second counter 34 in which the number of branch instructions fetched and pipelined by the instruction fetch unit and sent to the execution unit and not completely executed by the execution unit is stored.

The second counter 34 is incremented when the instruction fetch unit 14 fetches and pipelines a branch instruction 22 for an iteration of the loop 17 and is decremented when an information of a currently completed branch instruction 22 is received from the execution unit 16.

The number of future branch instructions 22 to be fetched and pipelined by the instruction fetch unit 14 can be calculated by determining the difference between the first counter 32 and the second counter 34. Therefore, an exact prediction of the last branch instruction to be fetched and pipelined is possible. The target address of the branch instruction can be determined exactly.

In general, the information of remaining loop iteration will be available in the execution unit 16 when executing the branch instruction 22 for the first time. This information is communicated to the branch prediction unit 12 which uses this information to predict the future behavior of the branch instruction 22. Even the loop exit will be predicted correctly.

In order to reduce communication in the processor and thus to reduce energy consumption of the processor, the execution unit only sends the number of remaining loop iteration to the branch prediction unit when the number of loop iterations is lower than a threshold value. The number of remaining iterations is compared with the threshold value and the number of remaining iterations is only sent from the execution unit to the branch prediction unit when the number of remaining loop iterations is less than or equal to the threshold value. This allows the implementation of small counters in the branch prediction tables. For example, the threshold value is 4 or 8 which allows the implementation of a counter comprising 2 or 3 bits only.

The number of branch instructions to be initiated in advance is smaller than the reference value in order to avoid fetching and pipelining of unnecessary instructions in advance and to determine the target address of the branch instruction exactly.

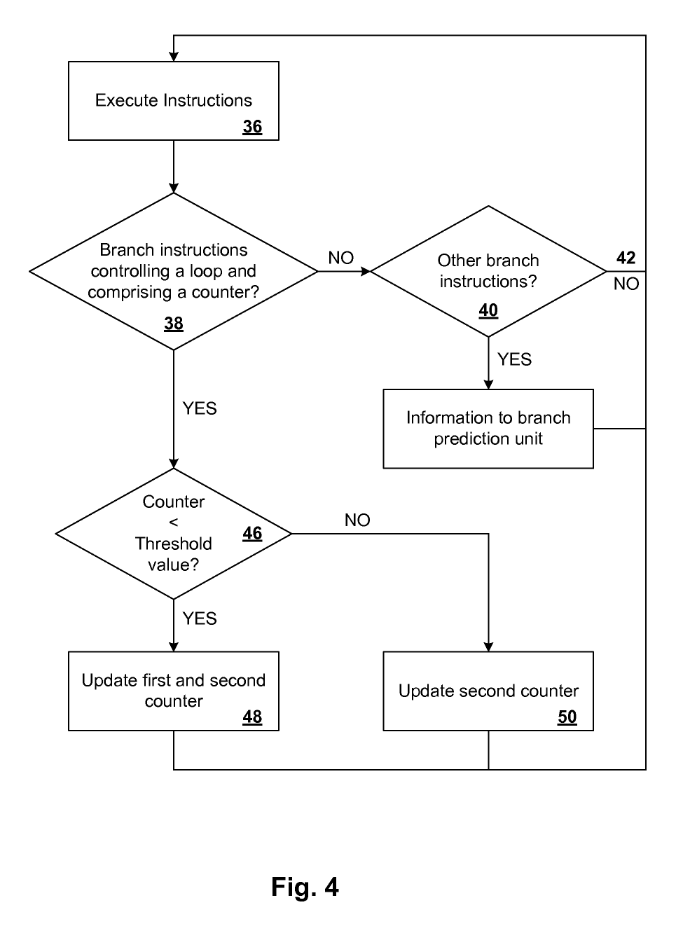

FIGS. 4 to 6 shows detailed flow diagrams of the execution unit and the branch prediction unit.

Referring to FIG. 4, the flow of information of the execution unit 16 is described.

The execution unit 16 receives an instruction to be executed fetched and pipelined by the instruction fetch unit 14 and starts executing this instruction (reference numeral 36).

The execution unit 16 determines if the instruction is a branch instruction controlling a loop and comprising a counter (reference numeral 38).

If the instruction is not a branch instruction controlling a loop and comprising a counter, it is determined if the instruction is another kind of branch instruction (reference numeral 40).

If the instruction is no kind of branch instruction, the instruction is executed and the next instruction to be executed is fetched (reference numeral 42).

If the instruction is a branch instruction not forming a loop, the instruction is executed, the target address is determined by the execution unit 16 and the instruction at the target address of the branch instruction can be executed.

If the instruction is a branch instruction 22 forming a loop and comprising a counter 24, the instruction is executed and the counter 24 is decremented or incremented depending on the kind of counter and the number of remaining loop iterations is determined as described above.

Finally, the number of remaining loop iterations is compared to the stored threshold value (reference numeral 46). If the number is smaller than or equal to the threshold value, an execution information for the instruction and the number of remaining loop iterations is sent to the branch prediction unit 12 (reference numeral 48). If the number is above the threshold value, only the execution information for the instruction is sent to the branch prediction unit 12 (reference numeral 50).

If the branch prediction unit receives an execution information, the second counter is decremented. If the branch prediction receives additionally the number of remaining loop iterations, the first counter is updated and the number of instructions to be initiated is determined.

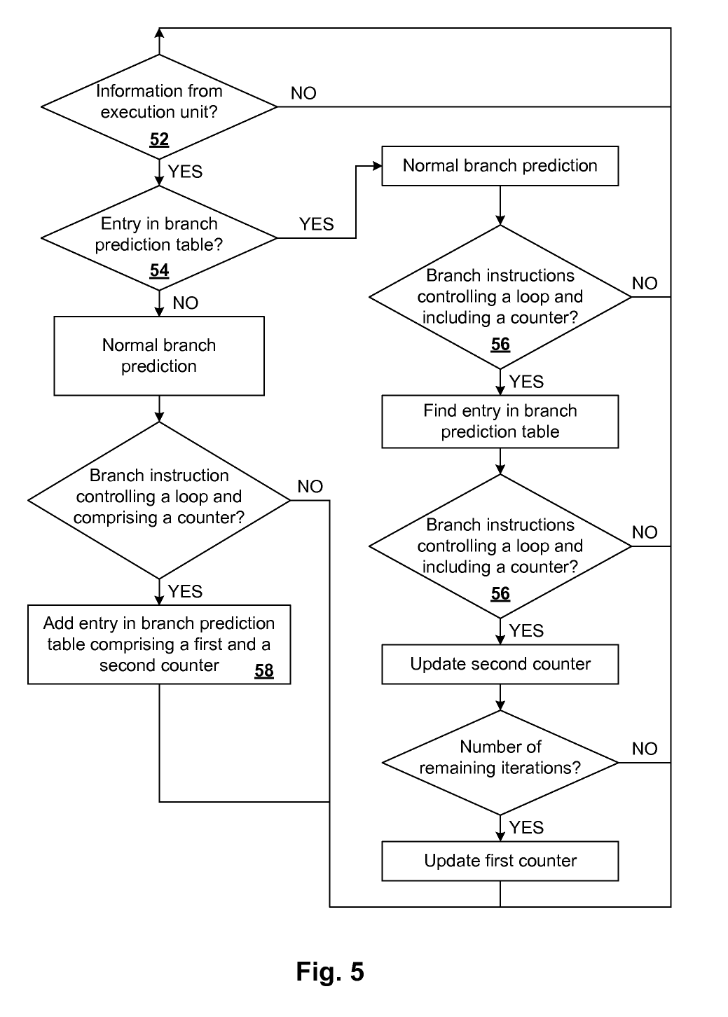

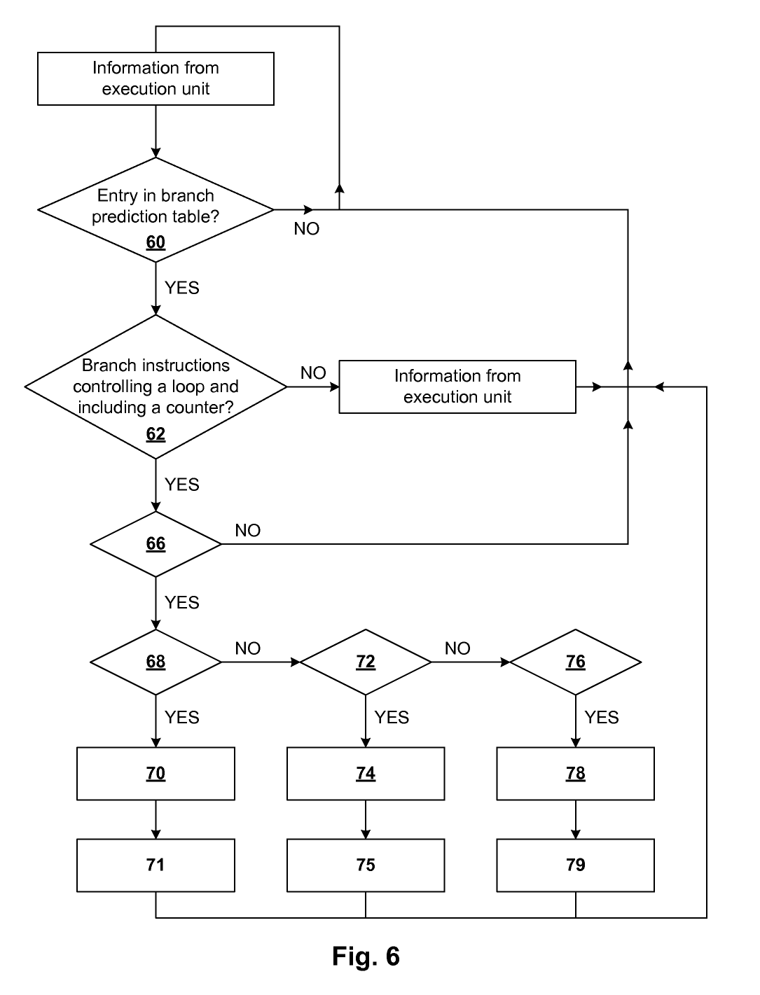

FIGS. 5 and 6 show the flow of information of the branch prediction unit 12.

FIG. 5 shows the update of the counters 32, 34 of the branch prediction table 30 of the branch prediction unit 12. First, the branch prediction unit 12 receives the execution information and the number of remaining iterations from the execution unit (reference numeral 52). Next, it is determined if the execution information and the number of remaining iterations belongs to a branch instruction which is already listed in the branch prediction table (reference numeral 54).

If the corresponding branch instruction 22 is already listed in a branch prediction table 30, it is determined whether the branch instruction 22 controls a loop and comprises a counter (reference numeral 56). If these conditions are fulfilled, the corresponding counters in the branch prediction tables are updated as mentioned above. If the instruction is a branch instruction without an instruction for a loop comprising a counter, the instruction is executed and the instruction following to the target address of the branch instruction can be executed.

If the branch instruction comprising a counter is not listed in the branch prediction table, a new branch prediction table entry is created in the branch prediction table comprising two counters, wherein the value of the second counter is zero and the value of first counter depends on whether a number of remaining iterations is sent by the execution unit (reference numeral 58).

FIG. 6 shows the information flow of the branch prediction unit of the information received from the execution unit.

After receiving this information it is determined whether an entry for the branch instruction referenced by this information can be found in the branch prediction tables (reference numeral 60). If an entry can be found it is determined whether the branch instruction forms a loop and comprises a counter (reference numeral 62).

If the instruction is a branch instruction without an instruction for controlling a loop iteration and without comprising a counter, the instruction is executed and the instruction following to the target address of the branch instruction can be executed (reference numeral 64).

If the instruction is a branch instruction controlling a loop iteration and comprising a counter it is determined whether the number of branch instructions fetched and pipelined by the instruction fetch unit and sent to the execution unit and not completely executed by the execution unit is smaller than a maximum number of instruction fetched and pipelined by the instruction fetch unit and sent to the execution unit and not completely executed by the execution unit (reference numeral 66).

If the maximum number is reached, no further branch instruction can be fetched and pipelined until the number is incremented. The number of remaining iterations of the loop 17 is only being sent to the branch prediction unit 12 if the number is smaller than the threshold value. If the number of branch instructions fetched and pipelined by the instruction fetch unit and sent to the execution unit is higher than the threshold value, a number of not required branch instructions would be fetched, pipelined and executed.

If the number is below the maximum number, it is determined whether the difference between the received number of remaining iterations of the loop and the number of branch instructions fetched and pipelined by the instruction fetch unit and sent to the execution unit and not completely executed by the execution unit is below zero (reference numeral 68).

If this condition is fulfilled, more branch instructions are fetched and pipelined than required for ending the loop. In this case, the branch prediction unit sends a default information to the instruction fetch unit and no further branch instructions are fetched and pipelined (reference numeral 70). Furthermore, the counter 24 is incremented or decremented as described above (reference numeral 71).

If the difference between the received number of remaining iterations of the loop and the number of branch instructions fetched and pipelined by the instruction fetch unit and sent to the execution unit and not completely executed by the execution unit is not below zero, it is determined whether the difference is zero (reference numeral 72).

If the difference is zero, the required number of branch instructions fetched and pipelined is reached and no further fetching and pipelining of branch instructions is required. Thus, the branch prediction unit 12 determined the loop exit. The instruction fetch unit can continue with fetching and pipelining subsequent instructions of the binary computer program (reference numeral 74). Furthermore, the counter 24 is incremented or decremented as described above (reference numeral 75).

If the difference is not zero it is determined that the difference is larger than zero (reference numeral 76). In this case, subsequent branch instructions can be fetched and pipelined until the difference is zero. The branch prediction unit 12 predicts the number of future branch instructions 22 to be fetched and pipelined on the basis of the calculated difference (reference numeral 78). Furthermore, the counter 24 is incremented or decremented as described above (reference numeral 79).

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others ordinary skilled in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The general idea is that all branch instructions controlling a loop and comprising a counter share the property that the number of iteration of the loop 17 is known when the loop 17 is entered. When having executed the branch instruction 22 for the first time it is known how many times it will be executed and after how many iterations the counter 24 will be equal to the reference value 26. In general, this information will be available in the execution unit 16 of the processor 10. This information is communicated to the branch prediction unit 12. The branch prediction unit 12 would use the information to predict the future behavior of the branch instruction (22) perfectly, i.e. even the loop exit will be predicted correctly.

In several embodiments, the execution unit 16 only sends the information to the branch prediction unit 12 when the number of iterations before loop exit is lower than some constant. This saves communication within the processor 10 and thus reduces energy consumption. It also allows the implementation to use small counters (2 or 3 bits only) in the branch prediction tables 30 of the branch prediction unit 12.

This method may have the advantage to be applicable to loops with arbitrarily high iteration count while recording a branch history is always limited. Also, this method does not require any learning but will predict the end of a loop at the first occurrence of the loop correctly. History-based prediction often fails to predict the first loop exit correctly. Furthermore, the method can predict the end of the loop when the number of iterations of the loop differs every time the loop is started again. Such loop patterns occur in certain numeric algorithms dealing with matrices.

In current processors 10 the branch prediction unit 12 works asynchronously to normal program execution. It identifies and predicts future branches independently. The branch prediction unit 12 may send an arbitrary number of branch instructions 22 to be fetched and pipelined by the instruction fetch unit 14 which takes care for (pre-)fetching instructions from the appropriate address.

In order to exploit information sent by the execution unit, the branch prediction unit needs to know, for each branch, how many branch instructions are fetched and pipelined by the instruction fetch unit and sent to the execution unit and not completely executed by the execution unit.

The number of branch instructions 22 to be fetched and pipelined by the instruction fetch unit 14 the branch prediction unit 12 can send in advance is limited by some small constant. The branch prediction unit 12 keeps a counter of branch instructions 22 which are fetched and pipelined by the instruction fetch unit 14 and sent to the execution unit and not completely executed by the execution unit 16.

This counter is incremented whenever the branch prediction unit 12 sends another instruction for fetching and pipelining a branch instruction 22 to the instruction fetch unit and gets decremented every time the execution unit 16 reports completion of the corresponding branch instruction. The execution unit 16 notifies the branch prediction unit 12 about every taken completed branch instruction anyway.

The execution unit 16 compares the value of the counter 24 of the branch instruction 22 with the reference value and sends the number of remaining iterations to the branch prediction unit once the difference between these values falls below a constant value. The branch prediction unit 12 then knows how many branch instruction are still needed to be fetched and pipelined, and when the branch will no longer be taken, thus correctly predicting (avoiding the misprediction upon) loop exit. Once the branch prediction unit 12 has received the number of remaining iterations, it keeps this value in a first counter (32).

The above described method is robust against unstructured code. Well-formed code as is typically generated by today's compilers will leave it to the branch instruction to modify the register keeping the loop counter and refrains from modifying the loop counter from within the loop body.

What is claimed is:

1. A computer-implemented method for predicting branch instructions in a processor, the method comprising:
processing a branch instruction of a binary computer program controlling a loop by an execution unit, the branch instruction being fetched by an instruction fetch unit and comprising a counter which is decremented or incremented when the branch instruction is completed and a reference value for a total number of iterations of the loop to be executed by the execution unit;
determining a number of remaining iterations for the loop by the execution unit from the counter and the reference value, for the processed branch instruction;
sending the number of remaining iterations of the loop from the execution unit to a branch prediction unit when the branch instruction is completely executed;
predicting, by the branch prediction unit, future behavior of the processed branch instruction on the basis of the number of remaining iterations of the loop; and
fetching and pipelining future instructions of the binary computer program by the instruction fetch unit depending on the prediction of the future behavior of the branch instruction.

2. The method of claim 1, wherein the processor includes:
the execution unit, wherein the execution unit is configured for executing machine instructions of the binary computer program;
the instruction fetch unit, wherein the instruction fetch unit is configured for fetching and pipelining instructions to be executed by the execution unit; and
the branch prediction unit, wherein the branch prediction unit is configured to predict the behavior of branch instructions executed by the execution unit.

3. The method of claim 1, wherein the number of remaining iterations of the loop being compared with a threshold value by the execution unit and the number of remaining loop iterations being sent from the execution unit to the branch prediction unit only when the number of remaining iterations of the loop is less than, or equal to, the threshold value.

4. The method of claim 3, wherein the threshold value being less than 8 or less than 4.

5. The method of claim 1, wherein a branch prediction table entry being generated in a branch prediction table in the branch prediction unit for the currently processed branch instruction, a first counter and a second counter being provided in the branch prediction table entry, the first counter storing the number of remaining iterations of the loop received from the execution unit, the second counter counting the number of branch instructions fetched and pipelined by the instruction fetch unit and sent to the execution unit and not completely executed by the execution unit, the number of the remaining branch instructions to be fetched and pipelined by the instruction fetch unit being determined depending on the values of the first and the second counter.

6. The method of claim 5, wherein the value of the second counter being decremented when an information of a currently completed branch instruction is received from the execution unit and being incremented when a branch instruction is fetched and pipelined by the instruction fetch unit.

7. The method of claim 1, wherein the number of branch instructions fetched and pipelined by the instruction fetch unit and not completely executed by the execution unit being less than or equal to the threshold value.

8. The method of claim 1, wherein the execution unit comparing the number of remaining iteration of the loop with the reference value and executing an iteration of the loop, if the number of remaining loop iterations is equal to the reference value.
